(19) United States
(12) Patent Application Publication
(10) Pub. No.: US 2008/0127749 A1
(43) Pub. Date: Jun. 5, 2008

(54) System for detecting axle loads

(75) Inventor: Markus Huber, Wagrain (AT)

Correspondence Address: ALLEMAN HALL MCCOY RUSSELL & TUTTLE LLP, 806 SW BROADWAY, SUITE 600, PORTLAND, OR, 97205-3335, US

(73) Assignee: Liebherr-Werk Bischofshofen GmbH, Bischofshofen (AT)

(21) Appl. No.: 11/985,483

(22) Filed: Nov. 14, 2007

(30) Foreign Application Priority Data
Nov. 21, 2006 (DE) 20 2006 017 721.3

(51) Int. Cl. G01L 1/22; E02F 9/26

(52) U.S. Cl. 73/862.045; 37/379

(57) ABSTRACT

The present disclosure relates to a system for detecting axle loads of a vehicle, in particular of a wheel loader, comprising a sensor for determining the torque of a drivetrain and a second sensor for detecting the load of an axle, wherein the second sensor is arranged on a non-rotating component of the axle.

### CROSS-REFERENCE TO RELATED APPLICATION

This application claims priority to German Utility Model Application Serial No. 20 2006 017 721.3 filed Nov. 21, 2006, which is hereby incorporated by reference in its entirety for all purposes.

### BACKGROUND

The present disclosure relates to a system for detecting axle loads of a vehicle, in particular of a wheel loader.

In construction-site vehicles such as wheel loaders, axles are very expensive components time-consuming to repair, whose service should be planned carefully. In addition, customers do not accept damages of the axles during the intended service life of the wheel loader.

If the condition of an axle could be measured and evaluated online for each serial machine, a specific planning of service would be possible. Severe damages of the axles, which involve a great repair effort, thereby could be avoided. Moreover, the data obtained could be included in the redesign of axles. As a result, it would be possible to even better adapt the axles to customer requirements.

So far, however, such measurement of the axle load has only been possible by using expensive measurement technology not suitable for everyday use or for series production. This is largely due to the fact that the torques must be detected on rotating shafts. Without this complex measurement technology, the individual axle moments so far cannot be determined, which is, however, urgently necessary for an evaluation of the service life of the axles.

Therefore, it is the object of the present disclosure to provide a simpler, less expensive measurement technology more suitable for series production.

### SUMMARY

In accordance with the present disclosure, this is satisfied by a system for detecting axle loads of a vehicle, in particular of a wheel loader. This system comprises a sensor for determining the torque of a drivetrain and a second sensor for detecting the load of an axle. In accordance with the present disclosure, the second sensor is arranged on a non-rotating component of the axle. As a result, the complex measurement technology on the rotating components can be omitted, as from the data of the second sensor, which is arranged on a non-rotating component of the axle, and the cumulative torque of the drivetrain those torques can be determined which are introduced into the axle. The position of the second sensor on the axle is chosen such that a clear relation exists between the measured loads and the torques introduced into the axle. As a result of this relation between the measured loads on the non-rotating component and the moments introduced into the axle, the axle torques thus can be determined from the cumulative torque.

Advantageously, at least one sensor is arranged on each axle for detecting the load of this axle. Thus, the system can determine the respective axle torques of the axles from the cumulative torque.

Furthermore advantageously, the system of the present disclosure comprises a sensor for determining the speed of the drivetrain and/or of the axle. This speed likewise can be included in the calculation of the torques introduced into the axle or in the evaluation of the service life of the axle.

Furthermore, the system of the present disclosure advantageously comprises a calculation unit for evaluating the data of the sensors. Said calculation unit receives the data of the sensors and thereby determines the torques introduced into the axles, as described above.

Advantageously, the calculation unit determines the torques introduced into the axle from the data on the torque and possibly on the speed and from the data of the second sensor.

Advantageously, the calculation unit uses predetermined values, in particular a conversion matrix, on the relation between the data measured by the sensors and the torques introduced into the axle. The relation in particular between the data from the second sensor on the load of the axle and the torques introduced into the axle thus is predetermined by measurement series and then stored in the calculation unit in particular in the form of a conversion matrix.

Advantageously, the calculation unit calculates a characteristic for evaluation of the service life of the axle. Advantageously, this characteristic is calculated on the basis of the torques introduced into the axle and from the speeds. This characteristic provides for a better assessment of the condition of the axle and the service life.

Advantageously, the system furthermore comprises a memory in which the characteristic for evaluation of the service life of the axle and/or further values determined from the data of the sensors are stored. Thus, all relevant data are stored in the system and can be used both for better service and for development of the axles.

Advantageously, the system furthermore includes an output for reading out data by a service system. In this way, the service system can simply be connected to the system for detecting axle loads of the vehicle, which provides for a specific planning of service. In particular, severe damage of the axles, which involves a great repair effort, thus can be avoided.

Further advantageously, the system of the present disclosure comprises a vehicle control to which data on the load of the axles are supplied and which actuates the vehicle such that damaging operating points are avoided. By means of this control of the vehicle, in particular accumulations of very damaging operating points can be avoided, whereby the service life of the axles can be increased considerably.

Advantageously, the second sensor of the system of the present disclosure is a strain gauge. By utilizing a strain gauge, the load of the axles can easily be measured in that the strain gauge is arranged on a non-rotating component of the axle in accordance with the present disclosure.

Furthermore, the present disclosure comprises a vehicle, in particular a wheel loader, comprising a system for detecting axle loads as described above. Such a vehicle has the same advantages as the corresponding system.

Furthermore, the present disclosure also comprises a method that includes: determining the torque of a drivetrain and detecting the load of an axle by a sensor arranged on a non-rotating component of the axle, the torques introduced into the axle being determined from the data on the torque and the data of the sensor arranged on a non-rotating component of the axle. This method has the same advantages as the system of the present disclosure for detecting axle loads of a vehicle.

### BRIEF DESCRIPTION OF THE FIGURES

The present disclosure will now be described in detail with reference to the drawings, in which:

FIG. 1 shows a wheel loader in accordance with the present disclosure,

FIG. 2 shows a first schematic diagram of the system of the present disclosure, and

FIG. 3 shows a further schematic diagram of the system of the present disclosure.

### DETAILED DESCRIPTION OF THE FIGURES

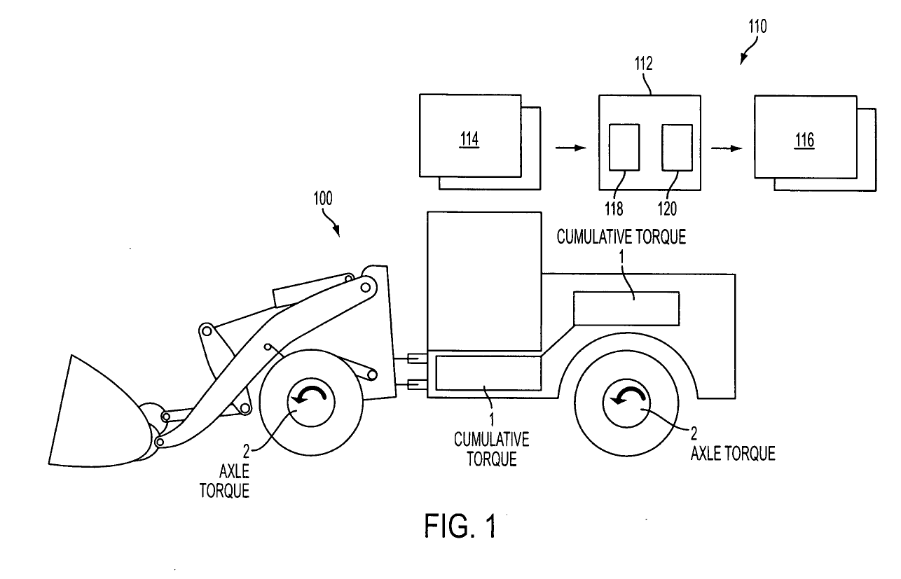

FIG. 1 shows a wheel loader 100 of the present disclosure. Wheel loader 100 includes a drivetrain 1 which provides a cumulative torque. The cumulative torque is provided for example by drivetrain units such as an internal combustion engine (e.g. a diesel engine), a converter transmission, a hydrostatic drive, an electric drive, etc. and can be determined there by generally known methods. The cumulative torques may be determined based on operating conditions of the drivetrain units, such as engine load, etc. Further, FIG. 1 shows a control system 110 having a controller 112, coupled to various sensors 114 and various actuators and/or readouts 116. In one example, the control system may calculate the cumulative torques based on conditions of the drivetrain units measured by one or more sensors 114. Control system 110 may also include a memory 118 and a calculation unit 120. For determining the axle torques introduced into the respective axles 2, the knowledge of the cumulative torques is, however, not sufficient.

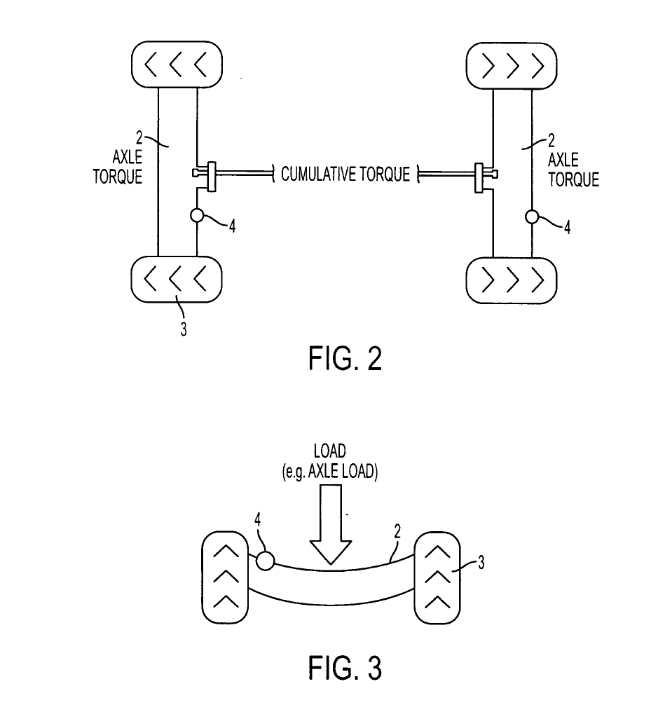

In the present disclosure, sensors 4 which measure the axle load therefore are arranged on each of the axles 2, as shown in FIG. 2. These sensors are mounted on the non-rotating components of the axle and may also communicate with control system 110. In this way, the loads acting on the axle bodies can be measured in a simple way. For this purpose, e.g. strain gauges are used, which are arranged on a non-rotating component of the axle body.

From the loads measured by the sensors on the non-rotating components of the axle and from the cumulative torque, the system of the present disclosure now determines the respective axle torques introduced into the axles. From these axle torques and from the speeds, a characteristic for evaluation of the service life of the axle continuously is calculated in the calculation unit and stored in memory. By reading out this characteristic, an evaluation of the service life and a specific planning of service thus are possible, which avoid major damages of the axles. In the case of an accumulation of very damaging operating points, the same likewise can be prevented by the machine control. For this purpose, the machine control is supplied with data of the system of the present disclosure and correspondingly actuates the wheel loader.

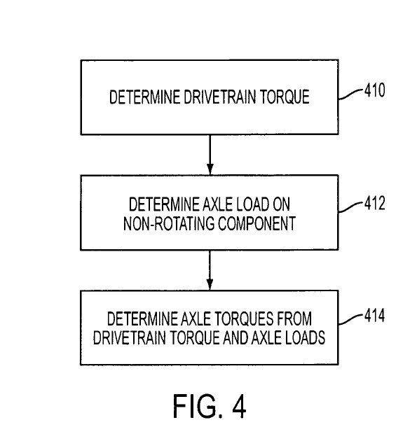

FIG. 3 now shows a schematic diagram with a sensor 4 arranged on a measuring point on a non-rotating component of the axle for detecting the load of the axle, by means of which the loads acting on the axle body 2 can be measured. The position on the axle, where the loads are measured, are chosen such that a clear relation exists between the measured load and the torques introduced into the axle. The Figure shows an example axle position for sensor location.

As a result, sensors can be omitted on the rotating components, as the axle torques can be determined from the measured loads and from the cumulative torques.

FIG. 4 shows an example method that includes at 410, determining the torque of a drivetrain, such as based on operating conditions of the drivetrain as noted above. Then, at 412, the method detects the load of an axle, such as from a sensor on non-rotating components as noted above. Then, in 414, the system determines the axle torques based on the above determined information.

1. A system for detecting axle loads of a vehicle having an axle, comprising:
a first sensor determining a torque of a drivetrain; and
a second sensor detecting a load of the axle, wherein the second sensor is arranged on a non-rotating component of the axle.

2. The system according to claim 1, wherein at least one sensor is associated to each of a plurality of axles for detecting loads of the respective axles.

3. The system according to claim 1, further comprising:
a third sensor for determining the speed of the drivetrain and/or of the axle.

4. The system according to claim 1, further comprising:
a calculation unit for evaluating data of the sensors.

5. The system according to claim 4, wherein the calculation unit determines torques introduced into the axle from data on the torque from the first sensor, from a speed, and from the data of the second sensor.

6. The system according to claim 4, wherein the calculation unit is configured to make the determination based on predetermined values including a conversion matrix, the predetermined values including a relation between data measured by the sensors and torques introduced into the axle.

7. The system according to claim 4, wherein the calculation unit calculates a characteristic for evaluation of a service life of the axle.

8. The system according to claim 7 further comprising:
a memory in which the characteristic for evaluation of the service life of the axle and/or further values determined from the data of the sensors are stored.

9. The system according to claim 1, further comprising:
an output for reading out data by a service system.

10. The system according to claim 1, further comprising:
a vehicle control to which data on the load of the axles are supplied and which actuates the vehicle such that damaging operating points are avoided.

11. The system according to claim 1, wherein the second sensor is a strain gauge.

12. The system according to claim 1, wherein the vehicle is a wheel loader.

13. A wheel loader, comprising:
a drivetrain unit coupled in the wheel loader;
an axle coupled to the drivetrain unit, the axle having a non-rotating component; and
a system for detecting axle loads of the wheel loader, the system including a first sensor coupled to the drivetrain; a second sensor coupled to the non-rotating component of the axle; and a unit to determine a torque of a drivetrain from the first sensor, a load of the axle from the second sensor, and to determine an axle torque based on the drivetrain torque and axle load.

14. The wheel loader of claim 13, wherein the controller determines a cumulative drivetrain torque, and determines a service life of the axle based on the determined axle torque.

15. The wheel loader of claim 14, further comprising a readout for displaying the service life.

16. The wheel loader of claim 15, further comprising a memory that stores a characteristic for evaluation of the service life of the axle.

17. The wheel loader of claim 13, wherein the system adjusts operation of the wheel loader based on the determined axle torque to avoid damaging operating points to the axle.

18. The wheel loader of claim 17, wherein the second sensor is a strain gauge.

19. A method of operating a wheel loader, the loader having a drivetrain unit and an axle coupled to the drivetrain unit, the axle having a non-rotating component, the method comprising:
determining a torque of the drivetrain from a first sensor coupled to the drivetrain unit;
determining a load of the axle from a second sensor coupled to the non-rotating component;
determining an axle torque based on the drivetrain torque and axle load;
evaluating a service life of the axle based on the determined axle torque; and
adjusting operation of the wheel loader based on the determined axle torque to avoid damaging operating points to the axle.
